(19) United States
(12) Patent Application Publication
(10) Pub. No.: US 2018/0241321 A1
(43) Pub. Date: Aug. 23, 2018

(54) VOLTAGE SOURCE CONVERTER AND CONTROL THEREOF

(71) Applicant: General Electric Technology GmbH, Baden (GB)

(72) Inventors: Robert WHITEHOUSE, Stafford, Staffordshire (GB); Colin Donald Murray OATES, Brocton, Stafford, Staffordshire (GB); David Reginald TRAINER, Derby, Derbyshire (GB); Francisco Javier CHIVITE ZABALZA, Stafford, Staffordshire (GB)

(21) Appl. No.: 15/751,686

(22) PCT Filed: Aug. 17, 2016
(86) PCT No.: PCT/EP2016/069517

§ 371 Date: Feb. 9, 2018

(30) Foreign Application Priority Data
Aug. 18, 2015 (GB) 1514633.5

(51) Int. Cl. H02M 7/797; H02M 1/12; H02J 3/36

(52) U.S. Cl. CPC H02M 7/797; H02J 2003/365; H02J 3/36; H02M 1/12

(57) ABSTRACT

This application relates to a voltage source converter, especially for use in High Voltage Direct Current power distribution/transmission, and to methods of control of such a voltage source converter. The voltage source converter has at least one phase limb having a high-side DC terminal, a low-side DC terminal and an AC terminal. In embodiments of the invention each phase limb comprises a voltage wave-shaper operable, in use, to provide a selectively variable voltage level. Each phase limb also has a switch arrangement operable to provide at least first and second switch states. In the first switch state the low-side DC terminal is electrically connected to the AC terminal via a first path that includes the voltage wave-shaper. In the second switch state the high-side DC terminal is electrically connected to the AC terminal via a second path that includes the voltage wave-shaper.

### FIELD OF INVENTION

This application relates to a voltage source converter and to methods and apparatus for control of a voltage source converter, and especially to a voltage source converter for use in high voltage power distribution and in particular to a voltage source converter having elements for voltage wave-shaping that may be shared between arms of a phase limb.

### BACKGROUND OF THE INVENTION

HVDC (high-voltage direct current) electrical power transmission uses direct current for the transmission of electrical power. This is an alternative to alternating current electrical power transmission which is more common. There are a number of benefits to using HVDC electrical power transmission.

In order to use HVDC electrical power transmission, it is typically necessary to convert alternating current (AC) to direct current (DC) and back again. Historically this has involved a six pulse bridge type topology based on elements such thyristors which, can be turned on at a desired point in the power cycle and remain conducting as long as they are forward biased. Such a converter is known as a line-commutated converter (LCC).

Recent developments in the power electronics field have led to an increased use of voltages-source converters (VSC) for AC-DC and DC-AC conversion. VSCs make use of series connected switching elements, typically insulated gate bipolar transistors (IGBTs) connected with respective antiparallel diodes, that can be controllably turned on and off. Such converters are sometimes referred as self-commutated converters.

VSCs typically comprise multiple converter arms, each of which connects one DC terminal to one AC terminal as illustrated in FIG. 1. FIG. 1 illustrates a typical VSC 100 for conversion to/from three phase AC. There are three phase limbs 101a, 101b and 101c, each of which connects a respective AC terminal 102a-c to the DC terminals DC+ and DC−. Each phase limb has two converter arms, an upper arm 103-U connecting the respective AC terminal to the high-side DC terminal DC+ and a lower arm 103-L connecting the respective AC terminal to the low-side DC terminal DC−.

Each converter arm comprises an apparatus which is commonly termed a valve and which typically comprises a plurality of series connected elements 104 which may be switched in a desired sequence.

In one form of known VSC, often referred to as a six pulse bridge, the valves comprise a plurality of series connected switching elements, typically an IGBT 105 connected with respective antiparallel diode 106, as illustrated by example element 104a. The IGBTs of each valve are switched together, i.e. substantially simultaneously, to electrically connect or disconnect the relevant AC and DC terminals. Thus valve of a converter arm effectively forms a single high voltage switch. The valves of a given phase limb are switched in anti-phase and by using a pulse width modulated (PWM) type switching scheme for each arm, conversion between AC and DC voltage can be achieved.

In high voltage applications where a large number of series connected IGBTs are required the approach does however require complex drive circuitry to ensure that the IGBTs switch at the same time as one another and may require additional large passive snubber components to ensure that the high voltage across the series connected IGBTs is shared correctly. In addition the IGBTs need to switch on and off several times over each cycle of the AC voltage frequency to control the harmonic currents. These factors can lead to relatively high losses in conversion, high levels of electromagnetic interference and a complex design.

In another known type of VSC, referred to a modular multilevel converter (MMC), the elements 104 of the converter arms are cells including an energy storage element, such as a capacitor 107, and a cell switch arrangement of IGBTs 105 that can be controlled so as to either connect the energy storage element in series between the terminals of the cell or bypass the energy storage element. FIG. 1 illustrates an example of such a cell 104b. Cell 104b illustrates IGBTs 105 in a half bridge arrangement but cells based on a full bridge arrangement are also known and may be used.

The cells of an MMC are often referred to as sub-modules with a plurality of cells forming a valve module. The series connection of such cells 104b is sometimes referred to as a chain-link circuit or chain-link converter or simply a chain-link.

The cells or sub-modules of a valve of an MMC type converter are controlled to connect or bypass their respective energy storage element at different times so as to vary over the time the voltage difference across the valve. By using a relatively large number of sub-modules and timing the switching appropriately the valve can synthesise a stepped waveform that approximates to a sine wave and which contain low level of harmonic distortion. As the various sub-modules are switched individually and the changes in voltage from switching an individual sub-module are relatively small a number of the problems associated with the six pulse bridge converter are avoided.

In the MMC design a high side terminal of each valve will, at least for part of the cycle, be connected to a voltage which is substantially equal to that of the high-side DC terminal, DC+, whilst the low side terminal of that valve is, at the same time, connected to a voltage which is substantially equal to the low-side DC terminal voltage, DC−. In other words each valve must be designed to withstand a voltage of V_{DC}, where V_{DC} is the voltage difference between the high-side and low-side DC terminals. This requires a large number of sub-modules with capacitors having relatively high capacitance values. The MMC converter may therefore require a relatively large number of components adding to the cost and size of the converter.

In some applications the size or footprint of a VSC may be a particular concern. For example HVDC is increasingly being considered for use with offshore wind farms. The electrical energy generated by the wind farms may be converted to HVDC by a suitable VSC station for transmission to shore. This requires a VSC to be located on an offshore platform. The costs associated with providing a suitable offshore platform can be considerable and thus the size or footprint of VSC station can be significant factor in such applications.

Recently a variant converter has been proposed wherein a series of connected cells is provided in a converter arm for providing a stepped voltage waveform as described, e.g. a series connection of cells of the form 104b (or a full-bridge variant) forming a chain-link converter, but each converter arm is turned off for at least part of the AC cycle. Thus the plurality of series connected cells 104b for voltage wave-shaping are connected in series with an arm switch, referred to as a director switch, formed from a plurality of switching elements, e.g. cells of the form 104a, which can be turned off when the relevant converter arm is in the off state and not conducting. Such a converter has been referred to as an Alternate-Arm-Converter. An example of such a converter is described in WO2010/149200.

In the AAC converter, when a particular converter arm is conducting the chain-link cells are switched in sequence to provide a desired waveform in a similar fashion as described above with respect to the MMC type converter. However in the AAC converter each of the converter arms of a phase limb is switched off for part of the AC cycle and during such a period the switching elements of the arm switch are turned off. When the converter arm is thus in an off state and not conducting the voltage across the arm is shared between the switching elements of the arm switch and the chain-link circuit. This can reduce the maximum voltage across the chain-link circuit, in use and reduce the voltage range required by the chain-link of each converter arm. For example if the upper converter arm is turned off for the negative part of the power cycle for that phase and used for voltage wave-shaping only during the positive part of the cycle, then the voltage range required and maximum voltage stress may be limited to V_{DC}/2. This means that the chain-link converter for each converter arm of an AAC converter may comprise fewer cells than for an equivalently rated MMC type converter, with relatively simple switching devices that are not as costly or sizeable providing the director switches of each converter arm.

In some applications however it may be wished to operate an AAC type converter with an overlap period where both converter arms are conducting which requires each converter chain-link to have a voltage range greater than V_{DC}/2. And even for the AAC type converter there are a significant number of power conversion cells that contain cell capacitors 107. These capacitors are relatively large, in order to handle the voltages required, and can represent about 70% of the volume and weight of the cell.

It would therefore be beneficial to provide a converter with good performance and operating characteristics but with a relatively small footprint.

### BRIEF SUMMARY

Embodiments of the invention are therefore directed at an improved converter and methods and apparatus for the control thereof that at least mitigate at least some of the above mentioned disadvantages.

Thus according to the present invention there is provided a voltage source converter including:
at least one phase limb having a high-side DC terminal, a low-side DC terminal and an AC terminal, each phase limb including:
   a voltage wave-shaper operable, in use, to provide a selectively variable voltage level; and
   a phase limb switch arrangement operable to provide at least first and second switch states, wherein in the first switch state the low-side DC terminal is electrically connected to the AC terminal via a first path that includes the voltage wave-shaper and in the second switch state the high-side DC terminal is electrically connected to the AC terminal via a second path that includes the voltage wave-shaper.

Embodiments thus relate to voltage source converters (VSCs) in which a voltage wave-shaper, i.e. a suitable chain-link circuit or the like, can be connected in series between the AC terminal of a phase limb and either of the high-side or low-side DC terminals of the phase limb. The voltage wave-shaper is thus effectively shared by the two converter arms of the phase limb which can allow a reduction in the number of components required, as will be described in more detail later.

The phase limb switch arrangement may be further operable to provide at least third and fourth switch states, wherein in the third switch state the high-side DC terminal is electrically connected to the AC terminal via a third path that bypasses the voltage wave-shaper and wherein in the fourth switch state the low-side DC terminal is electrically connected to the AC terminal via a fourth path that bypasses the first voltage wave-shaper. The voltage wave-shaper may therefore only be used in a transition period between one converter arm being conducting to the other arm being conducting.

The voltage wave-shaper may include a chain-link circuit including a series of cells, each cell including an energy storage element and a cell switch arrangement operable to selectively connect the energy storage element between the terminals of the cell or connect the terminals of the cell so as to bypass the energy storage element.

A phase limb controller may be configured to control the phase limb in a repeating sequence including at least:
a positive ramp mode in which the phase limb switch arrangement is controlled to provide a period of the first switch state followed by a period of the second switch state and the wave-shaper is controlled to provide a voltage level that increases over the period of the first switch state and subsequently decreases over the period of the second switch state; and
a negative ramp mode in which the phase limb switch arrangement is controlled to provide a period of the second switch state followed by a period of the first switch state and the wave-shaper is controlled to provide a voltage level that increases over the period of the second switch state and subsequently decreases over the period of the first switch state.

The phase limb controller may be configured to control the phase limb to repeatedly alternate between instances of the third and fourth switch states and to transition from the third switch state to the fourth switch state via the negative ramp mode and to transition from the fourth switch state to the third switch state via the positive ramp mode.

In some embodiments the voltage wave-shaper may be configured such that the voltage level can be selectively varied between a positive voltage level and a negative voltage level. For example the voltage wave-shaper may include a chain-link having cells with a full-bridge cell switch arrangement. In such embodiments the voltage wave-shaper may be connected in series with a fixed capacitance, i.e. a wave-shaper path which is connected between the relevant DC terminal and the AC terminal in the first and second switch states may include the fixed capacitance. In some embodiments the voltage wave-shaper may be operable, in use, to generate a voltage level of equal magnitude and opposite polarity to the voltage of the fixed capacitance in use.

In some embodiments the phase limb switch arrangement may include first and second upper arm switching blocks connected in series between the high-side DC terminal and the AC terminal and first and second lower arm switching blocks connected in series between the low-side DC terminal and the AC terminals. The voltage wave-shaper may be connected in a wave-shaper path that runs between an upper node between the first and second upper arm switching blocks and a lower node between the first and second lower arm switching blocks. Note that as used herein the term “block” shall refer to a functional unit of the apparatus, which may include one or more components, which may or may not be physically co-located.

The arm switching blocks may include a series of switching elements, e.g. IGBTs, so as to effectively provide an arm switch. Thus there may be first and second upper arm switches and first and second lower arm switches.

In some embodiments however the first upper arm switching block and the first lower arm switching block may each include an in-arm voltage wave-shaper. An in-arm wave-shaper controller may be configured to control the in arm wave-shapers of the first upper and first lower switching blocks to provide a variable voltage during the third and fourth switch states mentioned above respectively. The in-arm wave-shaper controller may form part of the phase limb controller mentioned above or may be separate therefore.

In some embodiments the in-arm wave-shapers may each include a plurality of series connected cells, each cell including an energy storage element and a full-bridge cell switch arrangement. In such a case in some embodiments the in-arm wave-shaper controller may be further configured to control the cells to block a fault current in the event of DC side fault.

In some embodiments the VSC may further include a high-side busbar voltage wave-shaper connected between a converter high-side DC terminal and the high-side DC terminals of each of phase limb and a low-side busbar voltage wave-shaper connected between a converter low-side DC terminal and the low-side DC terminals of each of phase limb. The busbar wave-shapers can be operated to help improve harmonic performance as will be described in more detail later.

A VSC as described above may be implemented on an off-shore platform.

Aspects also relate to a power distribution/transmission system including a VSC as described above.

In another aspect there is provided a method of operating a voltage source converter having at least one phase limb with a high-side DC terminal, a low-side DC terminal and an AC terminal, the method including:
switching each phase limb in a sequence of switch states including at least:
   a first switch state in which the low-side DC terminal is electrically connected to the AC terminal via a first path that includes a voltage wave-shaper; and
   a second switch state in which the high-side DC terminal is electrically connected to the AC terminal via a second path that includes said voltage wave-shaper.

The method may be implemented in any of the variants described above with respect to the first aspect.

In particular the sequence of switch states may include:
a positive ramp mode including a period of the first switch state followed by a period of the second switch state wherein the wave-shaper is controlled to provide a voltage level that increases over the period of the first switch state and subsequently decreases over the period of the second switch state; and
a negative ramp mode in which the phase limb switch arrangement is controlled to provide a period of the second switch state followed by a period of the first switch state and the wave-shaper is controlled to provide a voltage level that increases over the period of the second switch state and subsequently decreases over the period of the first switch state.

The sequence may further include at least third and fourth switch states, wherein in the third switch state the high-side DC terminal is electrically connected to the AC terminal via a third path that bypasses the voltage wave-shaper and wherein in the fourth switch state the low-side DC terminal is electrically connected to the AC terminal via a fourth path that bypasses the first voltage wave-shaper.

### BRIEF DESCRIPTION OF THE DRAWINGS

The invention will now be described by way of example only with respect to the accompanying drawings, of which:

FIG. 1 illustrates the general form of known voltage source converters;

FIG. 2 illustrates a voltage source converter having a shared voltage wave-shaper according to an embodiment of the invention;

FIG. 3 illustrates various switch states of the voltage source converter illustrated in FIG. 2

FIG. 4 illustrates one example of voltage waveforms for the voltage source converter illustrated in FIG. 2;

FIG. 5 illustrates a further embodiment of a voltage source converter with a fixed capacitance in series with the voltage wave-shaper;

FIG. 6 illustrates voltage waveforms for the voltage source converter illustrated in FIG. 5;

FIG. 7 illustrates another embodiment of a voltage source converter with in-arm wave-shapers;

FIG. 8 illustrates a further embodiment with busbar wave-shapers; and

FIG. 9 illustrates one example of voltage waveforms for the voltage source converter illustrated in FIG. 7.

### DETAILED DESCRIPTION

Embodiments of the present invention relate to voltage source converters with an active voltage wave-shaper, e.g. a chain-link circuit or the like for selectively providing one of a plurality of different possible voltage levels, where the wave-shaper may be shared by the upper and lower converter arms of a phase limb. Thus rather than each converter arm being provided with a separate chain-link, as would be the case with a conventional MMC or AAC type converter, one chain-link may be provided for the phase limb that can be switched between the AC terminal and either the high-side or low-side DC terminals as required.

FIG. 2 illustrates a voltage source converter (VSC) 200 according to an embodiment of the invention. FIG. 2 illustrates a phase limb 201 which is connected between a high-side DC terminal DC+ and a low-side DC terminal DC− and with an AC terminal 202. FIG. 2 illustrates just one phase limb for clarity but in practice there may be multiple, e.g. three, phase limbs, each connected between the high-side and low-side DC terminals DC+ and DC− and each having a respective AC terminal.

The phase limb has a phase limb switch arrangement which, in this example, comprises four switches. The phase limb switch arrangement has first and second upper arm switches S_{U1} and S_{U2} connected in series between the AC terminal 202 and the high side DC terminal DC+ to form an upper converter arm 203-U. The phase limb switch arrangement also has first and second lower arm switches S_{L1} and S_{L2} connected in series between the AC terminal 202 and the low side DC terminal DC− to form a lower converter arm 203-L.

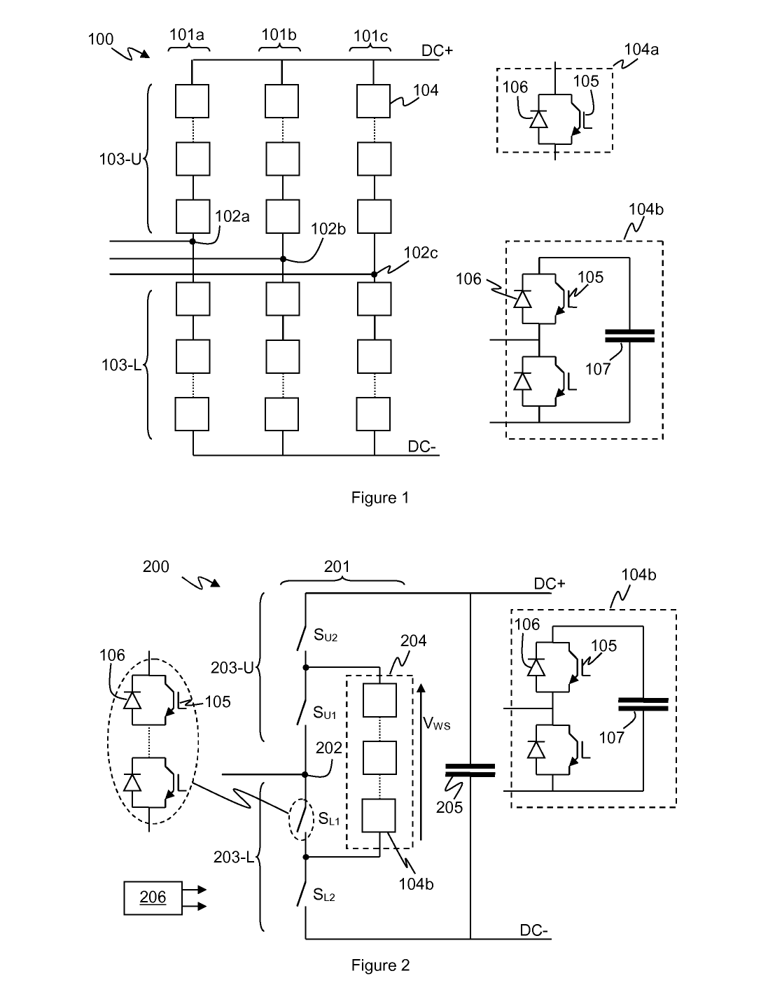

Each of the switches S_{U1}, S_{U2}, S_{L1}, S_{L2} may be implemented by a suitable series connection of switching elements, such as IGBTs 105 and antiparallel diodes 106 as described previously, e.g. a plurality of series connected switching elements of the form 104a illustrated in FIG. 1.

The phase limb also has an associated wave-shaper 204 which is operable, in use, to provide a voltage level across its terminals and where the voltage level provided can be selectively varied. The voltage wave-shaper may, for instance, comprise a chain-link circuit of a plurality of series connected cells 104b such as described above in relation to FIG. 1. As described such cells 104b may comprise an energy storage element such as a capacitor 107 and a cell switch arrangement of switching elements, such as IGBTs 105 and antiparallel diodes 106 such that the capacitor can be connected in series between the cell terminals or bypassed. FIG. 2 illustrates that the cells 104b of the wave-shaper 204 may have a half bridge cell switch arrangement but in some embodiments a full bridge cell switch arrangement may be used for at least some of the cells of the wave-shaper.

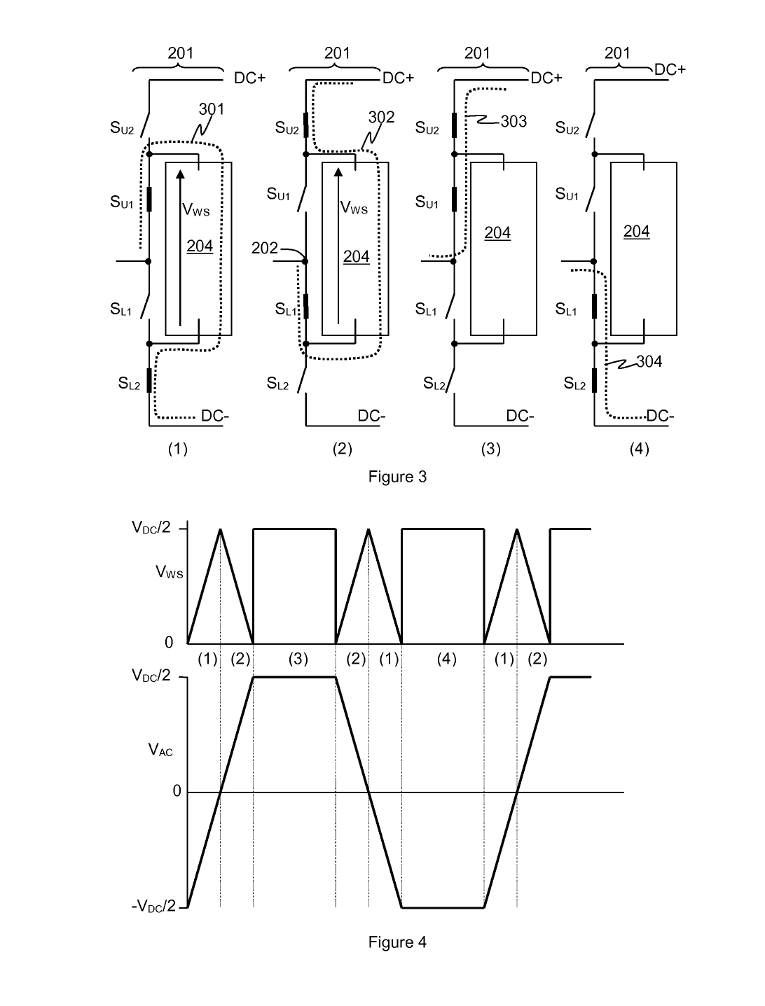

The phase limb switch arrangement, e.g. switches S_{U1}, S_{U2}, S_{L1}, S_{L2}, is operable in a number of different switch states as may be controlled by a suitable controller 206. In particular the phase limb switch arrangement is operable to provide at least first and second switch states, where in the first switch state the low-side DC terminal is electrically connected to the AC terminal via a first path that includes the voltage wave-shaper and in the second switch state the high-side DC terminal is electrically connected to the AC terminal via a second path that includes the voltage wave-shaper. FIG. 3 illustrates the first and second switch states as (1) and (2) respectively.

In the first switch state (1), switches S_{L2} and S_{U1} are closed, i.e. conducting, and switches S_{L1} and S_{U2} are open, i.e. non-conducting. This connects the lower end of the wave-shaper 204 to the low-side DC terminal and the upper end of the wave-shaper to the AC terminal 202. It will be seen that in this switch state the wave-shaper is connected in a first path 301 in series between the low-side DC terminal and the AC terminal and that the first path includes switch S_{U1} of the upper converter arm. In this state the voltage at the AC terminal will be equal to −VL+V_{WS} where V_{L} is the magnitude of the voltage at the low side terminal (i.e. typically V_{DC}/2) and V_{WS} is the present voltage level of the wave-shaper 204.

In the second switch state (2), switches S_{U2} and S_{L1} are closed, i.e. conducting, and switches S_{U1} and S_{L2} are open, i.e. non-conducting. This connects the upper end of the wave-shaper 204 to the high-side DC terminal and the lower end of the wave-shaper to the AC terminal 202. It will be seen that in this switch state the wave-shaper is connected in a second path 302 in series between the high-side DC terminal and the AC terminal and that the second path includes switch S_{L1} of the lower converter arm. In this state the voltage at the AC terminal will be equal to +V_{H}−V_{WS} where V_{H} is the magnitude of the voltage at the high side terminal (i.e. typically V_{DC}/2). It will be appreciated that is it the same wave-shaper that is connected in each of the first and the second paths.

If the magnitude of the DC voltage between the terminals is V_{DC} with |V_{H}|=|V_{L}|=|V_{DC}/2| and the wave-shaper 204 can generate a plurality of voltage levels that range from zero to at least +V_{DC}/2, then in the first switch state the contribution of the low-side DC voltage at the AC terminal can be varied from −V_{L} (i.e. −V_{DC}/2) to zero by varying the voltage of the wave-shaper. Likewise in the second switch state the contribution of the high-side DC voltage at the AC terminal can be varied from +V_{H} (i.e. +V_{DC}/2) to zero. By appropriately alternating between the first and second switch states and varying the voltage of the wave-shaper a desired voltage waveform, for instance a trapezoidal waveform may be generated.

FIG. 4 illustrates one example of waveforms that may be generated in a phase limb such as illustrated in FIG. 2 using the switch states illustrated in FIG. 3. For example, consider that the phase limb is in the first switch state and the voltage level V_{WS} of the wave-shaper is zero, such that the voltage at the AC terminal V_{AC} substantially corresponds to the low-side DC voltage, −V_{DC}/2. The voltage level of the wave-shaper 204 may be increased over time (e.g. ramped or stepped) to a level equal to V_{DC}/2, at which point the voltage at the AC terminal is substantially zero. At this point the phase limb is switched to the second switch state to connect the high-side terminal to the AC terminal via the wave-shaper. As the voltage of the wave-shaper is equal to +V_{DC}/2 the contribution of the high-side voltage to the voltage at the AC terminal at this point in time is zero. The voltage V_{WS} of the wave-shaper can then be reduced over time to increase the voltage at the AC terminal, until the voltage of the wave-shaper reaches zero and the voltage at the AC terminal is substantially equal to the high side voltage +V_{DC}. A period of operation in the first switch state with an increasing voltage level of the wave-shaper followed by a period of the second switch state with an decreasing voltage level of the wave-shaper thus provides a continuous full-scale positive ramp at the AC terminal and can thus be considered a positive ramp mode, as it corresponds to a positive ramp of voltage at the AC terminal.

For a trapezoidal waveform the phase limb may then be held in steady state at this high voltage level for a period of time. This could be achieved by maintaining the second switch state with the voltage level of the wave-shaper held to be zero.

In some embodiments however the phase limb may instead to be switched at this point in time to a different switch state in which the AC terminal is connected to the high-side DC terminal via a path that bypasses, i.e. does not include, the wave-shaper. As illustrated in FIG. 3 the phase limb switch arrangement may therefore be operable in a third switch state (3) where both of the upper side switches S_{U1} and S_{U2} are closed and both of the lower side switches S_{L1} and S_{L2} are open and the AC terminal is connected to the high side terminal DC+ by a third path 303 that bypasses the wave-shaper 204. Likewise the phase limb switch arrangement may also be operable in a fourth switch state (4) where both of the upper side switches S_{U1} and S_{U2} are open and both of the lower side switches S_{L1} and S_{L2} are closed and the AC terminal is connected to the low-side terminal DC+ by a fourth path 304 that bypasses the wave-shaper 204.

Referring back to FIG. 4, after the positive ramp mode reaches the high-side voltage, the phase limb may thus be switched to the third state (3) and maintained in this state for a period of time. Subsequently a negative ramp mode may then be initiated which comprises switching the phase limb to the second switch state and increasing the voltage of the wave-shaper to reduce the voltage at the AC terminal to zero, followed by, once zero is reached, switching the phase limb to the first switch state and decreasing the voltage of the wave-shaper down to zero. At this point in the time the AC voltage is thus substantially equal to the low-side voltage and the phase limb may be switched to the fourth switch state.

Use of the third and fourth switch states means that the voltage wave-shaper is only used during a commutation period where one converter arm of a phase limb is being taken out of conduction and the opposite arm brought into conduction. This can ensure that the capacitors in each cell of the chain-link forming the wave-shaper see equal positive and negative current time areas and can thus help is maintaining charge balance of the capacitors.

During the third and fourth switch states the voltage of the wave-shaper may be maintained at a non zero voltage, which in this embodiment may be a voltage of +V_{DC}/2. This can help ensure that the voltage across the converter arm that is not conducting is shared between the switches of that converter arm. For example consider the third state where the upper arm switches S_{U1} and S_{U2} are closed so the high-side DC terminal is connected to the AC terminal and the voltage wave-shaper is bypassed. In this state the AC terminal will be at a voltage which will be substantially the same as the voltage of the high side terminal. Thus the voltage across the lower converter arm will be substantially equal to V_{DC}.

It will be appreciated however that the node between the switches S_{L1} and S_{L2} of the lower converter arm may, in this state, still be connected via the voltage wave-shaper to the node between the upper switches S_{U1} and S_{U2}. If there was no voltage across the voltage wave-shaper these nodes may thus be at substantially the same voltage, in other words the voltage at the node between the lower switches would also be equal to the high side voltage +V_{DC}/2. This would result in substantially no voltage across switch S_{L1} and substantially the whole voltage V_{DC} being applied across switch S_{L2}.

In this state the voltage of the wave-shaper may thus be maintained at a voltage equal to +V_{DC}/2. Thus the voltage at the node between the lower converter arm switches S_{L1} and S_{L2} will be at a voltage V_{DC}/2 lower than the high-side voltage, i.e. at the midrange voltage. This ensures that there will be a voltage drop of V_{DC}/2 over switch S_{L1} and similarly a voltage drop of V_{DC}/2 over switch S_{L2} so that the voltage withstand is shared substantially equally between these switches.

A similar analysis applies for the fourth switch state. Thus in the third and fourth switch states the voltage of the wave-shaper may be maintained at a voltage so that the voltage of a wave-shaper path between the converter arms is substantially equal to half the voltage between the DC terminals.

It can therefore be seen that the same wave-shaper is used during both the positive and negative parts of the power cycle to generate (in this example) triangular waveforms. By switching of the phase limb switch arrangement a trapezoidal waveform is generated for the AC system. The controller 206 illustrated in FIG. 2 may be arranged to control the switch state of the arm switches and also the cells of the chain-link of the wave-shaper 204 to provide this trapezoidal waveform. It will be appreciated that the controller 206 is a functional unit and may be implemented in practice by a number of individual control elements that may be distributed at different levels of the converter in practice.

If the timings and magnitudes of the trapezoid are correctly determined the only components at the AC terminal phase voltage are fundamental and its triplen frequencies, i.e. the 3^{rd}, 9^{th} harmonic etc. These unwanted triplen harmonic frequencies can be circulated in a DELTA connected converter transformer auxiliary winding (not shown) and thus will not appear in the AC system terminals. The DC voltage will be the summation of all phases and will be essentially DC plus 6^{th} harmonic and its multiples. Various techniques may be used modify the wave-shaper voltage output to filter out the 6^{th} harmonic as will be understood from operation of other types of VSC.

In some embodiments the basic trapezoidal wave form could be modified to null other frequencies including harmonics and non-integer frequency harmonics that may be present in the AC and/or DC systems.

In some embodiments, referring back to FIG. 2, there may be an optional output capacitor 205 connected between the DC terminals, which may be used to reduce the distortion to the output waveforms.

It should be noted that with the illustrated switching profile of the wave-shaper, each of the switches S_{U1}, S_{U2}, S_{L1}, S_{L2} of the phase limb switching arrangement has an approximate voltage rating equivalent to half the DC voltage. The wave-shaper voltage profile can be changed to modify the DC and AC harmonics but may result in increases in the switch voltage ratings.

As mentioned above one voltage wave-shaper is thus effectively shared by both converter arms of a phase limb. The wave-shaper in the embodiment of FIG. 2 has a voltage range from zero to +V_{DC}/2 and can be implemented by a suitable chain-link of half-bridge cells. This significantly reduces the number of components compared to a conventional MMC type converter, in which each converter arm has a chain-link with a voltage rang of V_{DC} or an AAC type converter where each converter arm would have a chain-link rated for at least V_{DC}/2. This significantly reduces the number of cells required with substantial capacitors and thus results in a converter with a reduced footprint, i.e. size requirement, compared to equivalent converters of conventional design.

As shown the wave-shaper may be connected in a wave-shaper path that runs between an upper node between the first and second upper arm switches and a lower node between the first and second lower arm switches.

This arrangement is somewhat similar to a switch arrangement of a known so-called flying capacitor converter. In the conventional flying capacitor converter however a fixed capacitance is used and arranged so that it can be connected in series between either of the DC terminals and the AC terminal or bypassed as required. A conventional single stage flying capacitor converter thus typically provides only a single intermediate voltage between the high-side and low-side voltages. Additional voltage levels can be generated by using additional stages with different capacitance values, with a pair of switches in each converter arm for selectively including or bypassing the flying capacitor stage as required. Such an arrangement requires the use of multiple large capacitances of different values and a complex switch arrangement in each converter arm which is disadvantageous. Embodiments described herein use a simple phase limb switch arrangement and a wave-shaper with a variable voltage level.

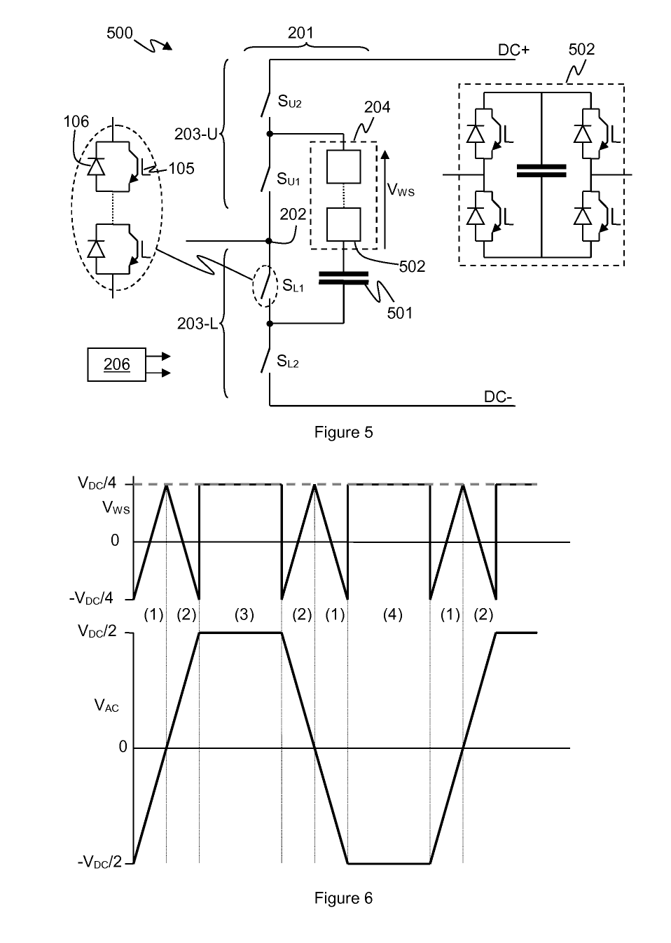

In some embodiments however a fixed capacitance may be used in the wave-shaper path to reduce the voltage range required by the voltage wave-shaper, as illustrated in FIG. 5, in which similar components to those mentioned previously are identified by the same reference numerals.

FIG. 5 illustrates a wave-shaper 204 connected in series with a fixed capacitance 501 in a wave-shaper path that extends from a node between the two switches S_{U1} and S_{U2} of the upper arm 203U to a node between the two switches S_{L1} and S_{L2} of the lower arm 203L. The fixed capacitance 501 is arranged to maintain a substantially constant voltage level of say +V_{DC}/4. In this embodiment the wave-shaper is arranged to provide a variable voltage level that varies between −V_{DC}/4 and +V_{DC}/4. Thus the voltage level can be selectively varied between a positive voltage level and a negative voltage level and in this example the voltage wave-shaper is operable, in use, to generate a voltage level of equal magnitude and opposite polarity to the voltage of the fixed capacitance in use.

When the voltage level of the wave-shaper is equal to −V_{DC}/4 the voltage from the wave-shaper and the fixed capacitance together result in a voltage of zero across the wave-shaper path. When the voltage level of the wave-shape is zero, only the voltage from the fixed capacitance contributes to the voltage across the wave-shaper path, which is thus V_{DC}/4. When the voltage level of the wave-shape is equal to +V_{DC}/4, this adds to the voltage from the fixed capacitance together to provide a total voltage of V_{DC}/2 across the wave-shaper path. Thus voltage across the wave-shaper path can be varied between zero and V_{DC}/2, as was the case for the embodiment shown in FIG. 2.

The embodiment of FIG. 5 may be operated in the same way as the embodiment described with reference to FIG. 2. FIG. 6 illustrates example waveforms for the embodiment of FIG. 5. The phase limb may be switched to the first switch state and the voltage of the wave-shaper increased (i.e. made less negative or more positive) from −V_{DC}/4 to +V_{DC}/4 to increase the voltage at the AC terminal from −V_{DC}/2 to zero. The phase limb may then be switched to the second switch state and the voltage of the wave-shaper decreased (i.e. made less positive or more negative) back down to −V_{DC}/4 to increase the AC voltage from zero to =V_{DC}/2.

As also shown the phase limb may also be connected in a third state where the upper switches are both closed and the lower switches are both open and a fourth switch state where the upper switches are both open and the lower switches are both closed. In the third and fourth states the voltage of the wave-shaper may be maintained at +V_{DC}/4 to maintain the voltage of the wave-shaper path at +V_{DC}/2.

The voltage wave-shaper in this example may comprise a chain-link circuit with cells 502 having a capacitor connected in a full bridge arrangement to allow the positive and negative voltages to be derived. This could reduce the number of cells required for the chain-link circuit, and hence the number of capacitors required, as the capacitors of the chain-link need only provide a voltage range of magnitude V_{DC}/4, albeit requiring full bridge cells and the fixed capacitance 501. This still may however use fewer components that the embodiment of FIG. 2 and thus represent a further reduction in size compared to a conventional converter design. Alternatively rather than use a chain-link converter of full-bridge cells the chain-link itself (which could be a chain-link of half-bridge cells) could be connected to the wave-shaper path via a switch arrangement that allows the chain-link to be selectively connected in series or anti-series with the fixed capacitance, i.e. such that the voltage of the wave-shaper adds to or acts against that of the fixed capacitance.

The converters described above thus offer operation similar to that of an AAC type converter but allow the use of fewer components with a consequent reduction in cost and size of the converter and also thus the cost and size of the required converter station.

In some embodiments the harmonic content of the AC and/or DC currents may be improved, e.g. reduced, by providing at least some additional wave-shaping functionality in a converter arm. Thus in addition to the wave-shaper 204 which is shared between the converter arm there may be at least one additional wave-shaper in each converter arm.

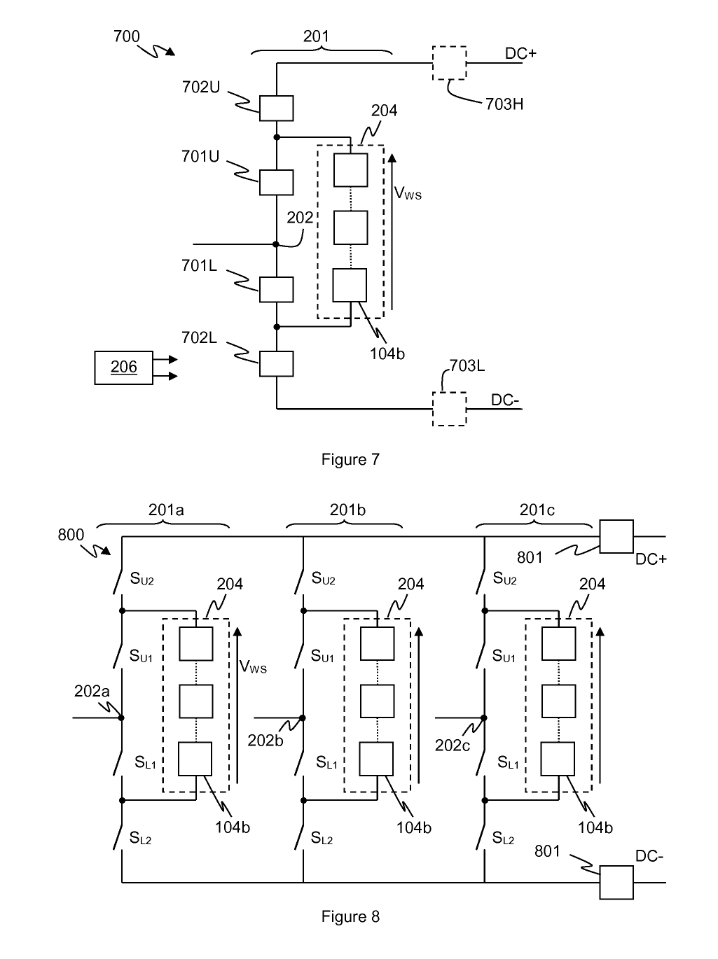

FIG. 7 illustrates generally a phase limb of a VSC according to such an embodiment. In general the phase limb has a switch arrangement comprising first and second upper arm switching blocks 701U and 702U in an upper converter arm and first and second upper arm switching blocks 701L and 702L in an upper converter arm. A wave-shaper 204 is connected in a wave-shaper path that extends between a node of the upper converter arm between the first and second upper arm switching blocks 701U and 702U and a node of the lower converter arm between the first and second lower arm switching blocks 701L and 702L. The wave-shaper may have any of the forms described above and/or there may be a fixed capacitance in the wave-shaper path as described previously. Note as used herein the term block shall refer to a functional unit comprising suitable circuitry.

The arm switching blocks are operable to provide the switch states referred to above, e.g. in a first switch state blocks 701U and 702L may be conducting with blocks 701L and 702U substantially non-conducting, and in a second switch state blocks 701L and 702U may be conducting with blocks 701U and 702L substantially non-conducting.

In some embodiments however both the first upper arm switching block 701U and the first lower arm switching block 701L may comprise an in-arm voltage wave-shaper. For example such switching blocks may be implemented, at least partly, as a chain-link circuit with wave-shaping capability. Alternatively both the second upper arm switching block 702U and the second lower arm switching block 702L may be implemented, at least partly, as a chain-link circuit with wave-shaping capability.

In use the voltage wave-shaper 204 may be controlled as described previously by a phase limb controller 206 to implement a positive ramp mode or a negative ramp mode as required to transition from one converter arm conducting to the other converter arm conducting. However in this embodiment in the third or fourth switch states when the wave-shaper 204 is bypassed the in-arm wave-shapers, i.e. the chain-links in each converter arm, may be controlled to provide voltage waveforms that improves the harmonic performance of the converter, e.g. by providing a better approximation of a sine wave. As such the in-arm wave-shapers may have a relatively limited voltage range and thus may comprise only a relatively few cells to provide such a voltage range. The in-arm wave-shapers may be controlled by an in-arm wave-shaper which may form part of the phase limb controller 206.

The in-arm wave-shapers may also be used to provide a voltage in the first and/or second switch states to provide part of the overall voltage differential between the AC terminal and the relevant DC terminal. This can help reduce the voltage range required for the main wave-shaper 204 and additionally to reduce voltage stress on the off state converter arm switches.

The in-arm wave-shapers may comprise a chain-link of full-bridge or half-bridge cells, although half bridge cells will give lower conduction losses due to fewer semiconductor switches in their implementation. Note if required both of the arm switching blocks of a converter arm could be implemented, at least partly, as a chain-link circuit with wave-shaping capability.

If at least some of the arm switching blocks do comprise a chain-link with full-bridge cells the phase arm may also be able to block DC side faults as will be understood by one skilled in the art, provided that a sufficient rating of full-bridge cells is provided. It will be understood that the embodiment illustrated in FIG. 2 or 5 may lack the ability to block at least some DC side fault due to the anti-parallel diodes of the arm switching elements providing a conduction path. In such embodiments a separate fault blocking element, such as a DC breaker, which may be common to the three phases, may be provided on the DC side.

In some embodiments a series of wave-shaping cells, which may for example be full-bridge cells, may be connected in series with the DC terminals, as illustrated in FIG. 8. FIG. 8 shows a VSC with three phase limbs 201a, 201b and 201c each connected between DC busbars that provide the DC terminals DC+ and DC− and each with a respective AC terminal 202a-c. Connected in series with the DC terminals, and thus in series with each of the phases 201a-c, are busbar wave-shapers comprising a plurality of full-bridge cells 801, i.e. a series connection of cells having the general form 502 illustrated in FIG. 5. As illustrated in FIG. 801 the full-bridge cells 801 may be connected in series with both high-side and low-side DC terminals.

These full-bridge cells 801 of the busbar wave-shapers can be controlled to effectively isolate the DC terminals from the converter at the 6^{th} harmonic frequency. The wave-shapers 204 of each phase limb is then controlled then use the resulting DC plus 3^{rd} harmonic wave form to construct (near) perfect fundamental frequency sine wave voltage profiles at the AC terminals of the converter.

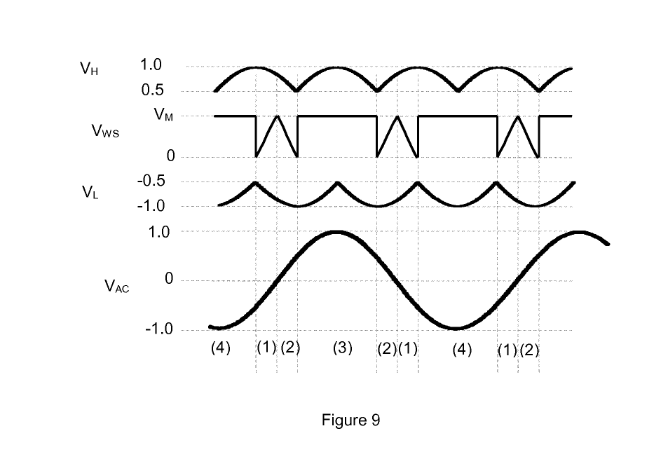

FIG. 9 illustrates example waveforms for such an embodiment. The full-bridge cells in the high-side DC busbar are controlled to create a varying high-side voltage V_{H} for the three phases. The variation of the high-side voltage V_{H} is arranged to correspond to the voltage variation expected over at least part of the positive half of each phase cycle, in this example the peak positive 120° of each phase cycle. The high side voltage thus varies by an amount equal to half positive AC voltage, i.e. +0.5 V_{AC}. The low-side voltage likewise corresponds to a suitable voltage variation for the peak negative 120° of each phase cycle, e.g. with a variation equal in magnitude to half the peak negative AC voltage, and thus may be out of phase with the variation of the low-side voltage by 180°.

Each phase limb be operated as described previously, e.g. in a repeating sequence of switch states (1), (2), (3), (2), (1), (4). In the third switch state however, when the wave-shaper for that phase is bypassed and the AC terminal is connected to the high-side DC busbar, the variation in the high-side voltage provides the required voltage variation. Likewise for the fourth switch state when the AC terminal is connected to the low-side DC busbar in a path that bypasses the wave-shaper 204 of that phase limb. To transition from the fourth switch state to the third switch state the phase limb may be switched to the first switch state and the voltage of the wave-shaper may be varied accordingly as described previously.

In this embodiment the wave-shaper may be used in the first and second states to provide voltage shaping during the transitions between the third and fourth states in the same manner as described previously to generate the desired AC waveform at the AC terminal. In this embodiment however the wave-shaper voltage during state 1 needs to also take into account the modulation of the low-side voltage and likewise in state 2 the variation in high-side voltage should be taken into account. During switch state (1), where the AC terminal is connected to the low-side DC busbar via the voltage wave-shaper the voltage at the AC terminal will be V_{L}+V_{WS}. In this embodiment however V_{L} is itself varying and thus the waveform for the wave-shaper will take this into account.

FIG. 9 shows an example of how the voltage V_{WS} may be controlled together with the variation in the high-side voltage V_{H} and the low side voltage V_{L} and also the resulting AC waveform at the AC terminal. Consider the sequence starting at switch state (3) where the AC terminal is connected directly to the high-side DC terminal. The voltage of the high-side DC terminal is modulated by the busbar wave-shaper 801 to provide the desired voltage variation for this part of the AC cycle for this phase. The voltage thus varies from half the positive AC peak voltage to the peak AC voltage and then back to half the positive AC peak voltage. At this point the voltage of the high-side busbar starts to increase again to provide the required modulation for one of the other phases. This phase limb thus switches to switch state (2) where the AC terminal is connected to the high-side busbar via the wave-shaper 204 and the voltage of the wave-shaper ramps up in a similar fashion as described previously to ramp down the voltage at the AC terminal. In this embodiment however the voltage ramp of the wave-shaper takes into account the variation of the high-side voltage to provide a desired AC waveform. The voltage of the wave-shaper ramps until the voltage of the AC voltage is zero—which occurs at a max ramp voltage, V_{M}. In this example zero voltage at the AC terminal is reached when the high-side voltage V_{H} corresponds to √3/2 of the peak AC voltage and this is thus the maximum ramp voltage of the wvae-shaper 204. The phase limb then switches to state (1) and the wave-shaper voltage ramps down in a similar fashion to provide the start of the negative phase until the voltage at the AC terminal reach half the peak negative voltage, at which point state (4) is adopted and the modulation of the low-side busbar voltage V_{L} provides the necessary voltage variation.

In this embodiment during the third and fourth switch states the voltage of the wave-shaper may be held at a relatively high voltage to aid in voltage sharing for the off state switches of the non-conducting converter arm as described previously. This could be a fixed voltage level that is held for the duration of the third or fourth switch state as illustrated in FIG. 9, for instance at a voltage at or around the maximum ramp voltage. In some embodiments however the voltage of the wave-shaper could be varied in accordance with the varying high-side and low-side voltages to maintain equal sharing between the off state switches.

It will of course be appreciated that other modulations of the high-side and low-side voltages may be implemented and/or different waveforms for the voltage of the wave-shaper 204 may be used to provide desired waveforms at the AC terminal.

In the event of a DC pole to pole fault the full-bridge cells 801 can be switched to block the flow of the fault current.

Embodiments of the present invention this provide VSCs and method of control therefore that provide good converter performance by the use of wave-shapers but share at least some wave-shaper components between the converter arms of a phase limb as required to reduce the number of components required and hence the cost and size of the converter.

VSCs of the present invention may be used in HVDC power distribution/transmission systems. A first VSC according to an embodiment may be arranged for the transfer or power to/from a second VSC, which may or may not be a VSC according to an embodiment of the invention. The VSCs could be arranged in a back-to-back arrangement in the same converter station or the first VSC could be remote from the second VSC and connected by a suitable Dc link, for instance via overhead lines and/or insulated cables. In some embodiments the first VSC could be part of a multi-point network with multiple other VSCs connected to the same DC grid.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A voltage source converter comprising:
at least one phase limb having a high-side DC terminal, a low-side DC terminal and an AC terminal, each phase limb comprising:
a voltage wave-shaper operable, in use, to provide a selectively variable voltage level; and
a phase limb switch arrangement operable to provide at least first and second switch states, wherein in the first switch state the low-side DC terminal is electrically connected to the AC terminal via a first path that includes the voltage wave-shaper and in the second switch state the high-side DC terminal is electrically connected to the AC terminal via a second path that includes the voltage wave-shaper.

2. The voltage source converter of claim 1, wherein the phase limb switch arrangement is further operable to provide at least third and fourth switch states, wherein in the third switch state the high-side DC terminal is electrically connected to the AC terminal via a third path that bypasses the voltage wave-shaper and wherein in the fourth switch state the low-side DC terminal is electrically connected to the AC terminal via a fourth path that bypasses the first voltage wave-shaper.

3. The voltage source converter of claim 1, wherein the voltage wave-shaper comprises a chain-link circuit comprising a series of cells, each cell comprising an energy storage element and a cell switch arrangement operable to selectively connect the energy storage element between terminals of the cell or connect the terminals of the cell so as to bypass the energy storage element.

4. The voltage source converter of claim 1, further comprising a phase limb controller configured to control the phase limb in a repeating sequence comprising at least:
a positive ramp mode in which the phase limb switch arrangement is controlled to provide a period of the first switch state followed by a period of the second switch state and the wave-shaper is controlled to provide a voltage level that increases over the period of the first switch state and subsequently decreases over the period of the second switch state; and
a negative ramp mode in which the phase limb switch arrangement is controlled to provide a period of the second switch state followed by a period of the first switch state and the wave-shaper is controlled to provide a voltage level that increases over the period of the second switch state and subsequently decreases over the period of the first switch state.

5. The voltage source converter of claim 4, wherein the phase limb controller is configured to control the phase limb to repeatedly alternate between instances of the third and fourth switch states and to transition from the third switch state to the fourth switch state via the negative ramp mode and to transition from the fourth switch state to the third switch state via the positive ramp mode.

6. The voltage source converter of claim 1, wherein the voltage wave-shaper is configured such that the voltage level can be selectively varied between a positive voltage level and a negative voltage level and wherein the voltage wave-shaper is in series with a fixed capacitance.

7. The voltage source converter of claim 6, wherein the voltage wave-shaper is operable, in use, to generate a voltage level of equal magnitude and opposite polarity to the voltage of the fixed capacitance in use.

8. The voltage source converter of claim 1, wherein the phase limb switch arrangement comprises first and second upper arm switching blocks connected in series between the high-side DC terminal and the AC terminal and first and second lower arm switching blocks connected in series between the low-side DC terminal and the AC terminals and wherein the voltage wave-shaper is connected in a wave-shaper path that runs between an upper node between the first and second upper arm switching blocks and a lower node between the first and second lower arm switching blocks.

9. The voltage source converter of claim 8, wherein the first upper arm switching block and the first lower arm switching block each comprises an in-arm voltage wave-shaper.

10. The voltage source converter of claim 9, comprising an in-arm wave-shaper controller configured to control the in arm wave-shapers of the first upper and first lower switching blocks to provide a variable voltage during said third and fourth switch states respectively.

11. The voltage source converter of claim 10, wherein the in-arm wave-shapers each comprise a plurality of series connected cells, each cell comprising an energy storage element and a full-bridge cell switch arrangement and wherein the in-arm wave-shaper controller is further configured to control the cells to block a fault current in the event of DC side fault.

12. The voltage source converter of claim 1, further comprising a high-side busbar voltage wave-shaper connected between a converter high-side DC terminal and the high-side DC terminals of each of phase limb and a low-side busbar voltage wave-shaper connected between a converter low-side DC terminal and the low-side DC terminals of each of phase limb.

13. A method of operating a voltage source converter having at least one phase limb with a high-side DC terminal, a low-side DC terminal and an AC terminal, the method comprising:
switching each phase limb in a sequence of switch states including at least:
a first switch state in which the low-side DC terminal is electrically connected to the AC terminal via a first path that includes a voltage wave-shaper; and
a second switch state in which the high-side DC terminal is electrically connected to the AC terminal via a second path that includes said voltage wave-shaper.

14. The method of claim 13, wherein the sequence comprises:
a positive ramp mode comprising a period of the first switch state followed by a period of the second switch state wherein the wave-shaper is controlled to provide a voltage level that increases over the period of the first switch state and subsequently decreases over the period of the second switch state; and
a negative ramp mode in which the phase limb switch arrangement is controlled to provide a period of the second switch state followed by a period of the first switch state and the wave-shaper is controlled to provide a voltage level that increases over the period of the second switch state and subsequently decreases over the period of the first switch state.

15. The method of claim 13, wherein the sequence further comprises at least third and fourth switch states, wherein in the third switch state the high-side DC terminal is electrically connected to the AC terminal via a third path that bypasses the voltage wave-shaper and wherein in the fourth switch state the low-side DC terminal is electrically connected to the AC terminal via a fourth path that bypasses the first voltage wave-shaper.
